(19) United States
(12) Patent Application Publication
(10) Pub. No.: US 2024/0338155 A1
(43) Pub. Date: Oct. 10, 2024

(54) INFORMATION PROCESSING APPARATUS, INSPECTION SYSTEM, METHOD OF CONTROLLING INFORMATION PROCESSING APPARATUS, AND METHOD OF CONTROLLING INSPECTION SYSTEM

(71) Applicant: CANON KABUSHIKI KAISHA, Tokyo (JP)

(72) Inventor: MASAAKI MURAISHI, Chiba (JP)

(21) Appl. No.: 18/629,572

(22) Filed: Apr. 8, 2024

(30) Foreign Application Priority Data
Apr. 10, 2023 (JP) 2023-063237

(51) Int. Cl. G06F 3/12; G06K 7/14; G06T 7/00; G06V 30/10

(52) U.S. Cl. CPC G06F 3/1208; G06F 3/1243; G06K 7/1413; G06K 7/1417; G06T 7/001; G06T 2207/10024; G06T 2207/30144; G06V 30/10

(57) ABSTRACT

An information processing apparatus includes one or more controllers having one or more processors and one or more memories, the one or more controllers being configured as an extractor configured to cause a reader to read a printed material sequentially conveyed from an image forming unit, and perform processing of extracting data from an image formed on the printed material, a display controller configured to display a received image on a display unit, and a setting unit configured to set, on the image displayed on the display unit, an area in which the extraction processing is performed. The display controller displays a margin area necessary for the extraction processing and identifiable with respect to the area set by the setting unit.

### BACKGROUND

### Field of the Disclosure

The present disclosure relates to an information processing apparatus, an inspection system, a method of controlling an information processing apparatus, and a method of controlling an inspection system.

### Description of the Related Art

Inspections to check whether printing has been correctly performed on materials have been manually performed. However, in recent years, an apparatus that automatically performs an inspection as post-processing after printing by a printing machine has been used. In such an inspection apparatus, an inspection is performed on variable area parts (variable data) such as a character string and a barcode in variable printing. Examples of such an inspection are a data readability inspection of checking whether a character string and a barcode are readable and a data comparison inspection of comparing the character string and the barcode with correct data. The data readability inspection and the data comparison inspection are referred to as a data inspection.

In Japanese Patent No. 7148012, a first area and a second area that are of different types can be set in a variable area in which content is variable, and different inspection processes are performed in the first and second areas to perform a data inspection. In the method described in Japanese Patent No. 7148012, the areas to be inspected can be recognized during setting of the areas to be inspected, but it is difficult for a user to recognize whether a margin area necessary for reading a character string and a barcode are secured. In the data inspection, a margin area is necessary to accurately read the character string and the barcode. In the data inspection, when a sufficient margin is not secured for the inspection areas designated during an inspection setting process, the recognition rate may decrease and the character string or the barcode may not be accurately read.

### SUMMARY

According to embodiments of the present disclosure, an information processing apparatus includes one or more controllers having one or more processors and one or more memories, the one or more controllers being configured as an extractor configured to cause a reader to read a printed material sequentially conveyed from an image forming unit, and perform processing of extracting data from an image formed on the printed material, a display controller configured to display a received image on a display unit, and a setting unit configured to set, on the image displayed on the display unit, an area in which the extraction processing is performed. The display controller displays a margin area necessary for the extraction processing and identifiable with respect to the area set by the setting unit.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of an inspection system including an inspection apparatus according to a first embodiment.

FIG. 2 is a diagram illustrating an example of an inner configuration of an image forming apparatus according to the first embodiment.

FIG. 3 is a diagram illustrating an example of an inner configuration of an inspection apparatus according to the first embodiment.

FIG. 4 is a flowchart illustrating an example of a whole inspection process according to the first embodiment.

FIG. 5 is a diagram illustrating an example of a UI screen for job management according to the first embodiment.

FIGS. 6A and 6B are diagrams illustrating an example of a UI screen for inspection settings according to the first embodiment.

FIG. 7 is a flowchart illustrating an example of an inspection setting process in step S403 according to the first embodiment.

FIG. 8 is a diagram illustrating examples of display of an inspection frame according to the first embodiment.

FIG. 9 is a diagram illustrating an example of margin information according to the first embodiment.

FIGS. 10A and 10B are diagrams illustrating an example of a warning screen according to the first embodiment.

FIG. 11 is a flowchart illustrating an example of an inspection setting process according to a second embodiment.

FIGS. 12A and 12B are diagrams illustrating an example of a shift in the position of a printed part according to the second embodiment.

FIGS. 13A, 13B, and 13C are diagrams illustrating an example of display of an inspection frame according to the second embodiment.

FIGS. 14A, 14B, and 14C are diagrams illustrating an example of display of an inspection frame in a character string area according to the second embodiment.

FIG. 15 is a flowchart illustrating an example of an inspection setting process according to a third embodiment.

FIGS. 16A, 16B, and 16C are diagrams illustrating examples of display of an inspection frame according to the third embodiment.

### DESCRIPTION OF THE EMBODIMENTS

Each embodiment of the present disclosure is described with reference to the accompanying drawings. The following embodiments do not limit the disclosure, and all combinations of features described in the embodiments are not necessarily essential to some embodiments of the present disclosure.

In the following description, an image forming apparatus may be also referred to a multifunction machine or a multifunction peripheral (MFP).

### First Embodiment

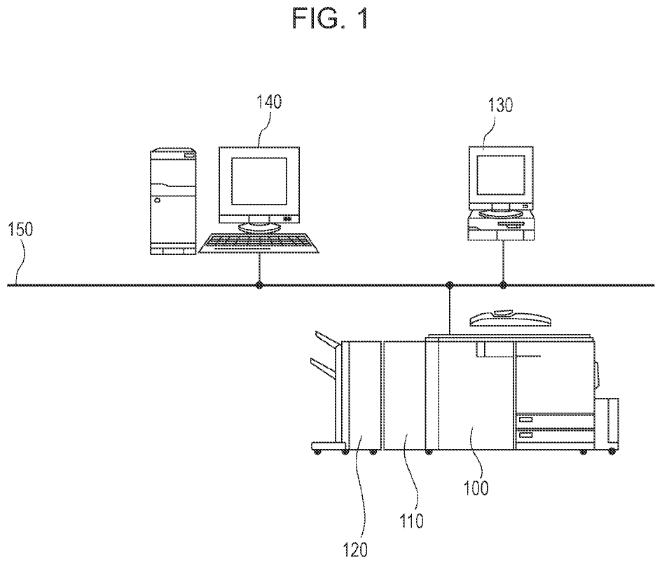

FIG. 1 is a diagram illustrating a configuration of an inspection system including an inspection apparatus according to a first embodiment of the present disclosure.

100 indicates the image forming apparatus, 110 indicates the inspection apparatus, 120 indicates a finisher, 130 indicates a client PC, 140 indicates a print server, and 150 indicates a network.

The image forming apparatus 100 performs printing and outputting based on various input data, for example, print data transmitted from the client PC 130 and the print server 140.

In the present embodiment, the image forming apparatus is described. However, the present embodiment is not limited thereto. The image forming apparatus may be any apparatus as long as the apparatus performs printing on a recording medium. For example, the image forming apparatus may perform printing on metal. The inspection system according to the present embodiment includes at least the image forming apparatus 100 that performs printing on a sheet, and the inspection apparatus 110 that inspects a printed material.

The inspection apparatus 110 inspects whether a printed material sequentially conveyed from the image forming apparatus 100 has a defect. In this case, the defect reduces the quality of the printed material. The defect is, for example, dirt caused by a color material adhering to an inappropriate part of the printed material during printing, or a color loss caused by a color material not sufficiently adhering to an appropriate part of the printed material during printing.

The inspection apparatus 110 inspects variable area parts such as one-dimensional codes such as a character string and a barcode and a two-dimensional code such as a QR code (registered trademark) in variable printing of the variable area parts. For example, the inspection apparatus 110 performs a data readability inspection to check whether a character string and a barcode are readable, and performs a data comparison inspection to compare results of reading the character string and the barcode with correct data. That is, the inspection apparatus 110 performs a printed image inspection to detect whether a pattern part of a printed material is abnormal, and performs a data inspection including the data readability inspection and the data comparison inspection. An inspection processing unit that performs the printed image inspection and the data inspection is included in the inspection apparatus 110, but may not be included in the inspection apparatus 110. For example, an information processing apparatus (not illustrated) as an inspection PC communicably connected to the inspection apparatus 110 may perform an inspection process. In the present embodiment, a barcode inspection indicates an inspection to inspect a barcode and a two-dimensional code such as a QR code.

The finisher 120 receives an output sheet inspected by the inspection apparatus 110, and switches a destination of the sheet based on results of the inspections by the inspection apparatus 110. The finisher 120 performs post-processing (sheet binding, stapling, and the like) and discharges the sheet when necessary.

The image forming apparatus 100 is connected to the client PC 130 and the print server 140 via the network 150 and connected to the inspection apparatus 110 and the finisher 120 via a communication cable. The inspection apparatus 110 is connected to the finisher 120 via a communication cable, in addition to the image forming apparatus 100. In the present embodiment, as an example, an in-line inspection apparatus that performs image formation, the inspections, post-processing, and sheet discharge is used. However, the present embodiment is not intended to limit the present disclosure.

### Configuration of Image Forming Apparatus

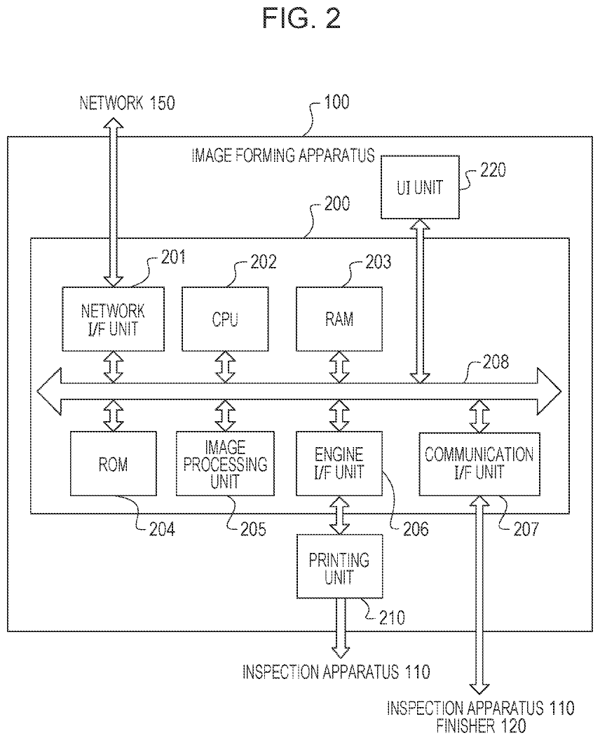

FIG. 2 is a diagram illustrating an inner configuration of the image forming apparatus 100 according to the present embodiment.

A controller 200 receives an image and a document from the network 150 and converts the received image and the received document into print data. A printing unit 210 produces a printed material by printing the print data on a recording sheet (paper or sheet). An UI unit 220 displays a screen and receives, from a user, an instruction to select sheet information for the image forming apparatus 100. The image forming apparatus includes the controller 200, the printing unit 210, and the UI unit 220.

201 to 208 indicate components of the controller 200.

The network interface (I/F) unit 201 transmits and receives data to and from the client PC 130 and the print server 140 via the network 150. The CPU 202 controls the whole image forming apparatus 100.

The RAM 203 is a work area for the CPU 202 to execute various commands. The ROM 204 stores program data that is executed by the CPU 202 when the image forming apparatus 100 is started. The ROM 204 also stores setting data for the controller 200, and the like.

The image processing unit 205 performs raster image processor (RIP) processing to convert an image and document data received from the network 150 into print data.

In the present embodiment, the RIP processing may not be performed by the image processing unit 205. For example, the RIP processing may be performed by an information processing apparatus (not illustrated) communicably connected to the image forming apparatus 100.

The engine interface (I/F) unit 206 transmits the print data to the printing unit 210.

The communication I/F unit 207 communicates with the inspection apparatus 110 and the finisher 120. The component 208 is an internal bus (system bus).

The image and the document created on the client PC 130 or the print server 140 on the network 150 are transmitted as page description language (PDL) data to the image forming apparatus 100 via a network (for example, a local area network). A print job for the image and the document may be transmitted to an information processing apparatus (not illustrated) via a network and managed by the information processing apparatus. The print job may be transmitted from the information processing apparatus to the image forming apparatus 100 via the network 150, and the image forming apparatus 100 may perform printing on a sheet.

The transmitted PDL data is stored in the RAM 203 via the network I/F unit 201. A print instruction issued by the user via the UI unit 220 is stored in the RAM 203 via the internal bus 208. The print instruction issued by the user is, for example, an instruction to select a sheet type.

The image processing unit 205 acquires the PDL data stored in the RAM 203, and performs image processing to convert the PDL data into print data. The image processing of converting the PDL data into the print data is to rasterize the PDL data, convert the rasterized data into multivalued bitmap data, and perform screen processing or the like on the bitmap data to convert the bitmap data into binary bitmap data. The binary bitmap data obtained by the image processing unit 205 is transmitted to the printing unit 210 via the engine I/F unit 206.

The printing unit 210 prints the received binary bitmap data on a recording sheet using a color material. The CPU 202 issues an instruction to the printing unit 210 based on the print instruction issued by the user and stored in the RAM 203. For example, when an instruction to perform printing on coated paper is issued, the CPU 202 issues, to the printing unit 210, an instruction to output paper from a paper cassette (not illustrated) in which coated paper is stored in the image forming apparatus 100. A full-color toner image is formed on the paper by the CPU 202 controlling various types of processing from the reception of the above-described PDL data to printing on the paper.

### Inner Configuration of Inspection Apparatus 110

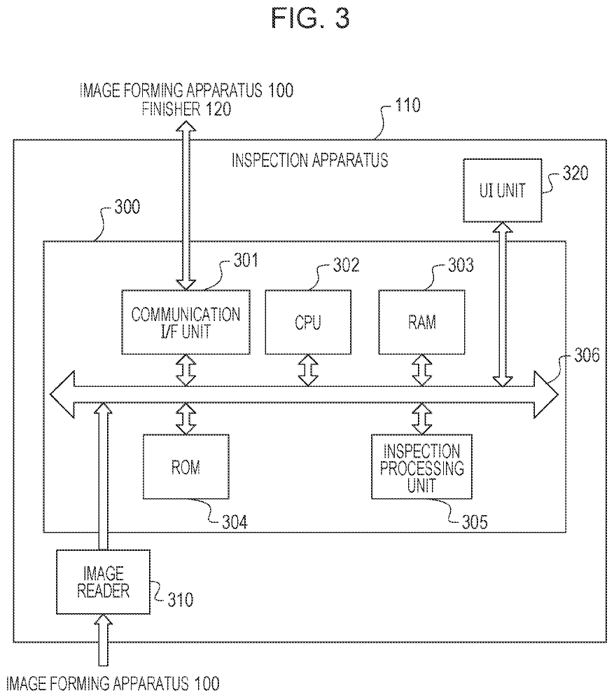

FIG. 3 is a diagram illustrating an inner configuration of the inspection apparatus 110.

An inspection controller 300 controls the whole inspection apparatus 110 and controls an inspection process of inspecting whether a printed material has a defect.

An image reader 310 reads the printed material conveyed from the image forming apparatus 100.

The image reader 310 generates a scanned image (read sheet) by reading the printed material.

An UI unit 320 is provided for making settings for the inspection apparatus 110 by the user and displaying an inspection result to the user. The settings for the inspection apparatus 110 by the user are items regarding what types of defects to inspect during the inspection of the printed material. The inspection items are, for example, a round defect (spot) and a line defect (streak). The inspection apparatus 110 includes the inspection controller 300, the image reader 310, and the UI unit 320 described above. In the present embodiment, the UI unit 320 includes a display unit that displays a screen, and a display controller that controls the screen displayed on the display unit. For the settings for the inspection apparatus 110 and the display of the inspection result on the UI unit 320, an external device such as the UI unit 220 of the image forming apparatus 100 described above, an inspection PC (not illustrated), or an information processing apparatus (not illustrated) may display the inspection result and receive an instruction.

301 to 306 indicate components of the inspection controller 300. The communication interface (I/F) unit 301 transmits and receives data to and from the image forming apparatus 100, the finisher 120, and an inserter 160. The CPU 302 controls the whole inspection apparatus 110. The RAM 303 is a work area for the CPU 302 to execute various commands. The ROM 304 stores program data that is executed by the CPU 302 when the inspection apparatus 110 is started. The ROM 304 also stores setting data for the inspection controller 300, and the like. A correct CSV file described later is stored in the ROM 304. The inspection processing unit 305 inspects whether a printed material has a defect. The internal bus 306 is a system bus.

### Printed Image Inspection

An outline of the printed image inspection to be performed by the inspection apparatus 110 is described below. The inspection apparatus 110 causes the image reader 310 to read a printed material conveyed from the image forming apparatus 100 to obtain a scanned image (read image) of the printed material to be inspected. The obtained scanned image of the printed material to be inspected is stored in the RAM 303. Subsequently, the inspection apparatus 110 causes the inspection processing unit 305 to calculate a differential value between a reference image stored as a correct image in the RAM 303 in advance and the scanned image of the printed material to be inspected.

Next, the inspection apparatus 110 performs an inspection by comparing the calculated differential value with inspection thresholds (contrast, size, and the like) for the inspection items for each pixel. A result of the inspection is stored in the RAM 303. For example, information indicating whether the printed material has a defect, a type (spot or streak) of the detected defect, positional information of the defect to be displayed on the UI unit 320, and the like are stored in the RAM 303.

### Data Inspection

An outline of the data inspection to be performed by the inspection apparatus 110 is described below. The inspection apparatus 110 causes the image reader 310 to read a printed material sequentially conveyed from the image forming apparatus 100 and obtain a scanned image of the printed material to be inspected. The obtained scanned image of the printed material is stored in the RAM 303. Subsequently, the inspection processing unit 305 of the inspection apparatus 110 performs processing of extracting data from a character string and a barcode or a QR code in the scanned image. The extraction processing is performed using preset glyph fonts for character recognition (optical character recognition (OCR)) and a barcode standard, and OCR is performed on characters of the character string. Decoding is performed on the barcode. In the data inspection, an inspection is performed to inspect whether the character string and the barcode within an area set to perform the data inspection are readable. When the character string and the barcode are readable, the inspection apparatus 110 determines that the inspected printed material is acceptable. When the character string and the barcode are not readable, the inspection apparatus 110 determines that the inspected printed material is not acceptable. In addition, the data comparison inspection can be performed to inspect whether results of reading the character string and the barcode as extracted data match corresponding data (correct data) of a correct CSV file prepared in advance. Even in this case, when the results of the data comparison inspection match the correct data, the inspection apparatus 110 determines that the inspected printed material is acceptable. When the results of the comparison inspection do not match the correct data, the inspection apparatus 110 determines that the inspected printed material is not acceptable. The results of the inspection are stored in the RAM 303. For example, the results of reading the character string and the barcode from the printed material, the results of the comparison with the correct data, positional information of read characters of the character string and the read barcode to be displayed on the UI unit 320, and the like are stored in the RAM 303.

Next, the inspection apparatus 110 causes the CPU 302 to instruct the UI unit 320 to display the inspection results stored in the RAM 303. When the inspection results are displayed on the UI unit 320, the user can recognize the inspection results.

When the image forming apparatus 100 produces a printed material with a defect or continuously produces a certain number of printed materials with defects, the inspection apparatus 110 causes the CPU 302 to transmit information indicating that the printed material with the defect has been produced or information indicating that the printed materials with the defects have been produced to the image forming apparatus 100 via the communication I/F unit 301.

The information indicating that the printed material with the defect has been produced or the information indicating that the printed materials with the defects have been produced is received by the controller 200 via the communication I/F unit 207. When the controller 200 receives the information, the CPU 202 instructs the printing unit 210 to stop printing. The image forming apparatus 100 stops a print operation when the instruction to stop the printing is issued to the printing unit 210.

The inspection apparatus 110 causes the CPU 302 to transmit information to the finisher 120 via the communication I/F unit 301 based on the inspection results stored in the RAM 303. The information transmitted to the finisher 120 indicates whether each printed material has a defect. The finisher 120 uses the received information to discharge a printed material without a defect to a normal sheet discharge tray and discharge a printed material with a defect to another tray different from the normal sheet discharge tray.

### Whole Procedure of Inspection Process

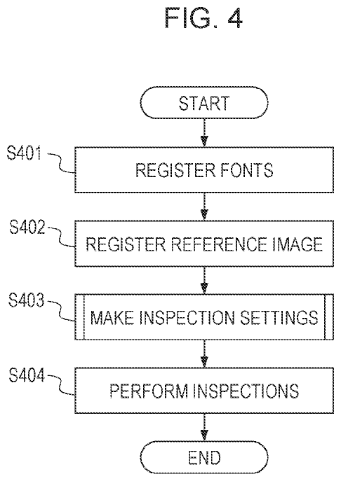

Next, a whole procedure from a registration operation before the start of an inspection to the execution of the inspection in the inspection apparatus 110 is described with reference to a flowchart illustrated in FIG. 4.

A process in the flowchart illustrated in FIG. 4 is implemented by the CPU 302 developing a program code stored in the ROM 304 into the RAM 303 and reading and executing the program code developed in the RAM 303.

In step S401, the CPU 302 registers glyph fonts. The registered glyph fonts are used for the data inspection. The glyph fonts are data in which glyph images of characters necessary for character recognition (OCR) to be performed during the data inspection are associated with character codes.

In a procedure of creating the glyph fonts, first, the inspection apparatus 110 waits in a mode for reading glyph font images and receives a print job for creating the glyph fonts from the client PC 130. The inspection apparatus 110 receives a glyph font job from the client PC 130 and reads the glyph font images. When the image forming apparatus 100 performs printing, the inspection apparatus 110 detects conveyance of a printed material from the image forming apparatus 100, causes the image reader 310 to scan an image of the printed material, and stores the scanned image in the RAM 303 of the inspection apparatus 110. When character images to be subjected to OCR are cut out of the scanned image one by one, and the user enters character codes for the cutout character images, the glyph fonts can be created. The created glyph fonts are stored in the RAM 303 of the inspection apparatus 110. The method of creating the glyph fonds according to the present embodiment is described above, but the present embodiment is not limited thereto. Any method may be used as long as data in which the character codes are associated with the character images cut out of the scanned image can be created. The data inspection may not be performed and only the printed image inspection may be performed. In this case, S401 is not performed and the process proceeds to S402.

In step S402, the CPU 302 registers a reference image as a correct image for the inspection. The inspection apparatus 110 waits in a mode for reading the reference image, receives a print job for registering the reference image from the client PC 130, and executes the print job for registering the reference image. When the image forming apparatus 100 performs printing, the inspection apparatus 110 detects conveyance of a printed material, causes the image reader 310 to scan an image of the printed material, and stores the scanned image as the reference image in the RAM 303 of the inspection apparatus 110.

In the present embodiment, the image reader 310 performs the scanning and the CPU 302 registers the reference image. However, the present embodiment is not limited thereto. For example, the print server 140 or the image processing unit 205 of the image forming apparatus 100 may register an image subjected to the RIP processing as the reference image.

In step S403, the CPU 302 stores various inspection setting values for an inspection area, an inspection level, and the like to the RAM 303 of the inspection apparatus 110 in accordance with inspection settings set by the user. Details of S403 according to the present embodiment are described later.

In step S404, the CPU 302 receives a print job for inspection from the client PC 130, detects conveyance of a sheet, causes the image reader 310 to scan an image of the sheet, and stores the scanned image to the RAM 303 of the inspection apparatus 110. Then, the inspection apparatus 110 performs a pattern inspection using the image scanned for the job for inspection, the reference image registered in S402, and the inspection setting values set in S403. In addition, the inspection apparatus 110 performs the data inspection using the glyph fonts registered in step S401 and the inspection settings set in step S403. Then, the process in the flowchart illustrated in FIG. 4 ends.

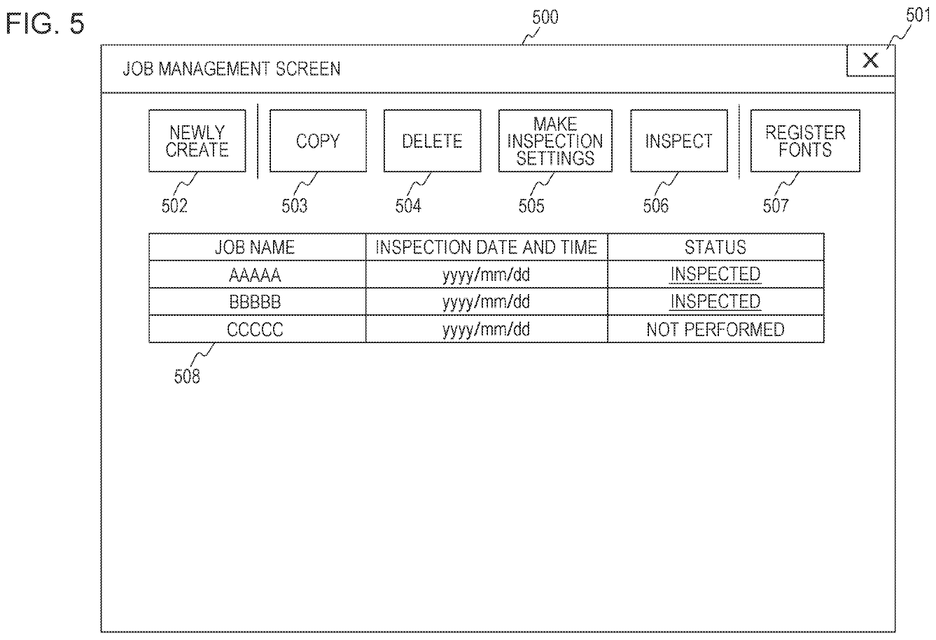

FIG. 5 is a diagram illustrating an example of a job management screen 500 displayed on the UI unit 320.

The job management screen 500 is displayed when the inspection apparatus 110 is started. Alternatively, the job management screen 500 is displayed when an application is started by a user operation from the UI unit 320.

The process in the flowchart illustrated in FIG. 4 can proceed to the steps of registering the fonts, registering the reference image, making the inspection settings, and performing the inspections on the job management screen 500.

A button 501 is provided for deleting the displayed screen 500.

A button 502 is provided for newly creating an inspection job and registering a reference image.

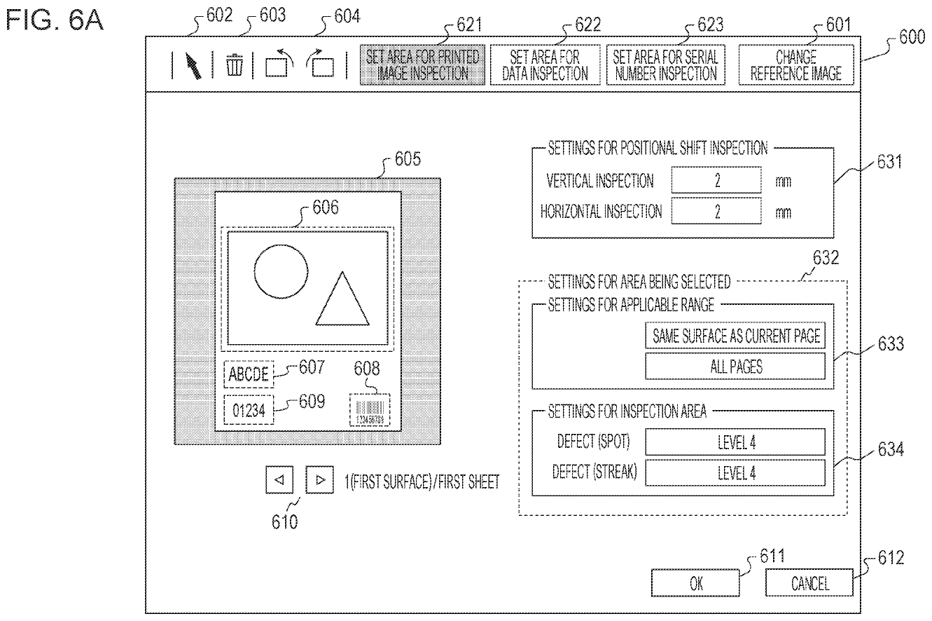

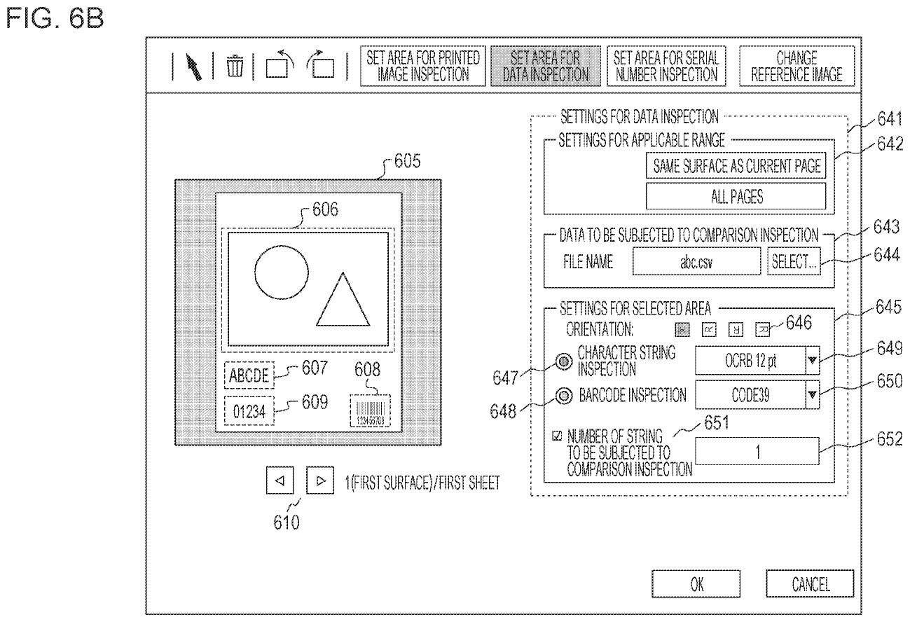

A button 503 is provided for copying a created inspection job. The button 503 is pressed to copy an inspection job selected in an inspection job list 508. When the inspection job is copied, it is possible to copy a reference image and inspection settings and newly perform an inspection. When the button 503 is pressed, the screen transitions to an inspection setting screen illustrated in FIGS. 6A and 6B.

A button 504 is a delete button. The button 504 is pressed to delete an inspection job selected in the inspection job list 508. When a plurality of inspection jobs is selected and the button 504 is pressed, the plurality of inspection jobs can be simultaneously deleted.

A button 505 is a make inspection settings button and is provided for making inspection settings for an inspection job for which the registration of a reference image has been completed.

A button 506 is an inspect button and is provided for performing an inspection for an inspection job for which the registration of a reference image and the making of inspection settings have been completed.

A button 507 is a register fonts button and is provided for registering the glyph fonts.

### Inspection Settings

Next, the inspection settings are described with reference to FIGS. 6A and 6B.

FIG. 6A is a diagram illustrating an example of the inspection setting screen 600 displayed on the UI unit 320 of the inspection apparatus 110 to make the inspection settings.

A button 601 is a change reference image button and is used to change a reference image.

A button 602 is provided for selecting an inspection area and is pressed by an operator to select an already set area.

A button 603 is provided for deleting an inspection area and is pressed by the operator to delete a selected area.

A button 604 is provided for rotating an image displayed in an area 605.

The area 605 is a display area in which a read reference image is displayed. In a case where a plurality of sheets is read, the button 610 is pressed to switch a displayed image and switch front and rear surfaces of the read sheets.

A button 611 is an OK button for storing settings on the screen 600 and causing the screen to transition to the job management screen 500 illustrated in FIG. 5. The screen may transition to an inspection screen (not illustrated) by pressing the button 611 such that an inspection can be performed.

A button 612 is a cancel button for causing the screen to transition to the job management screen 500 illustrated in FIG. 5 without storing settings on the screen 600.

A button 621 is pressed by the operator to newly create an area for the printed image inspection. After the button 621 is pressed, the operator sets an inspection area for a reference image displayed in the area 605. An area 606 indicates an example of a setting in a printed image inspection area.

A button 622 is pressed by the operator to newly create an area for a character inspection or a barcode inspection. After the button 622 is pressed, the operator sets an inspection area on a reference image displayed in the area 605. A character area 607 indicates an example of a setting in a character inspection area. An area 608 indicates an example of a setting in a barcode inspection area. In FIGS. 6A and 6B, the area 606, the character area 607, and the area 608 are indicated by dotted lines of the same black. However, the area 606, the character area 607, and the area 608 may be displayed such that the area 606, the character area 607, and the area 608 can be identified as areas in which different types of processing are performed. For example, frames of the areas in which the different types of processing are performed may be displayed in different colors or may be displayed using different broken lines. The user may select colors of the frames to be displayed.

A button 623 is pressed by the operator to newly create an area for the serial number inspection. After the button 623 is pressed, the operator sets an inspection area for a reference image displayed in the area 605. The serial number inspection is to inspect data based on a predetermined rule. The predetermined rule is defined by a start number, an end number, an increased or decreased value, and the like.

A setting item 631 is for making settings for a positional shift inspection. In the setting item 631, an allowable amount of a shift in the position of a printed part from a reference image is set. In the present embodiment, an example in which 2 mm is designated by the operator as the allowable amount of the shift in the position of the printed part such that when the printed part shifts in position by 2 mm or more, the shift is detected. That is, the value designated by the operator corresponds to a threshold for positional shift detection. When the amount of a shift in the position of a printed part is equal to or larger than the set threshold and is detected, the inspection apparatus 110 determines that an inspected printed material is not acceptable.

A setting area 632 is a group of UIs for making settings for an area being selected in the area 605.

In a setting item 633, an applicable range of an area being selected is set. In a case where nothing is selected in the setting item 633, an inspection area being selected is arranged on only a page being displayed in the area 605. In a case where the “same surface as the current page” is selected, an inspection area being selected is arranged on the page of the same surface based on whether the inspection area being selected is arranged on a front surface or a rear surface of a sheet. In a case where “all pages” are selected, the inspection area being selected is arranged on all the pages.

A setting item 634 is for making settings for a round defect (spot) and a line defect (streak) and setting detection levels for the defects. The detection levels are parameters that are set in a stepwise manner to indicate the sizes of the spot and the streak to be determined to be defects. For example, each of the parameters is set to any of five levels from level 1 to level 5. When the parameters are set to level 5, it is possible to detect thinner and smaller defects than those to be detected when the parameters are set to level 1. In addition, the levels can be set for each inspection item. For example, while the spot is set to level 5, the streak is set to level 4. In the example illustrated in FIG. 6A, in the setting item 634, level 4 as the inspection level for the defect (spot) and level 4 as the inspection level for the defect (streak) are selected by the operator.

FIG. 6B is a diagram illustrating an example of the inspection setting screen in a case where a setting area being selected is a data area.

A setting area 641 is a group of UIs for making settings for a data inspection area displayed in a case where the data inspection area is selected in the area 605.

Although a case where the character area 607 is selected as the area being selected is described, similar settings are made for a character area 609. It is assumed that areas are displayed in the area 605 such that an area being selected is identifiable with respect to an unselected area.

In a setting area 642, an applicable range of an area being selected is set. In a case where any area is not selected, an inspection area being selected is arranged on a page currently displayed in the area 605. In a case where the “same surface as the current page” is selected, an inspection area being selected is arranged on the page on the same surface based on whether the inspection area being selected is arranged on a front surface or a rear surface of a sheet. In a case where “all pages” are selected, the inspection area being selected is arranged on all the pages.

In a setting area 643, a correct CSV file to be compared when the comparison inspection is performed is set. A button 644 is pressed to select a file, and the name of the selected file is displayed. The designation of the correct CSV file is common to the character inspection and the barcode inspection.

In a setting area 645, a data inspection area being selected is set. In the setting area 645, the orientation of a character, the selection of a character area or a barcode inspection area, a font type, a barcode type, whether the comparison inspection is to be performed, and a number of a string to be compared with the correct CSV file are designated.

In a setting item 646, the orientation of a character in the character area 607 is set.

In a setting item 647 and a setting item 648, a character string inspection or a barcode inspection is designated for an area being selected.

In a setting item 649, a font for performing OCR on the character area 607 is set.

In a setting item 650, a barcode type is set when the barcode inspection is selected in the setting item 648.

In a setting item 651, whether the comparison inspection is to be performed is set. When the comparison inspection is set to be “performed”, the OCR is performed on the character area 607 using the correct CSV file designated in the setting area 643 and the string number designated in the setting item 652, and the comparison inspection is performed to compare a read character string with the character string designated in the correct CSV file.

In the present embodiment, as the data inspection, the data readability inspection of checking whether a character string and a barcode are readable and the data comparison inspection of comparing results of reading the character string and the barcode with correct data are described as an example. However, the present embodiment is not limited thereto. For example, as the data inspection, a serial number inspection of checking whether results of reading are serial numbers, a front/rear inspection of inspecting whether results of reading front and rear surfaces of a sheet match correct data, and the like may be performed. It suffices for the data inspection to be performed by reading a character string and a barcode.

### Procedure of Inspection Setting Process

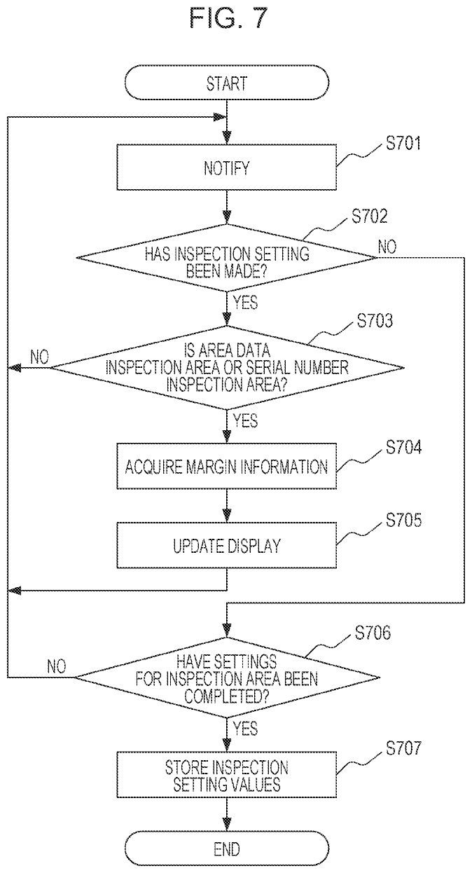

Next, a procedure of an inspection setting process in step S403 is described with reference to a flowchart illustrated in FIG. 7.

The process in the flowchart illustrated in FIG. 7 is implemented by the CPU 302 of the inspection apparatus 110 developing a program code stored in the ROM 304 into the RAM 303 and reading and executing the program code developed in the RAM 303.

In step S701, the CPU 302 receives a notification of a UI operation by the user from the UI unit 320.

In step S702, the CPU 302 determines whether an inspection setting has been made. Specifically, when an inspection area is newly created, the CPU 302 determines whether a setting for the already created inspection area has been changed. When the inspection setting is made (YES in step S702), the process proceeds to step S703. When an operation other than the making of the inspection setting is performed (NO in step S702), the process proceeds to step S706.

In step S703, the CPU 302 determines whether an area for which the inspection setting has been made in step S702 is a data inspection area or a serial number inspection area. When the data inspection area or the serial number inspection area is set (YES in step S703), the process proceeds to step S704. When an area other than the data inspection area and the serial number inspection area is set (NO in step S703), the process returns to step S701 and the CPU 302 waits for a notification of a UI operation.

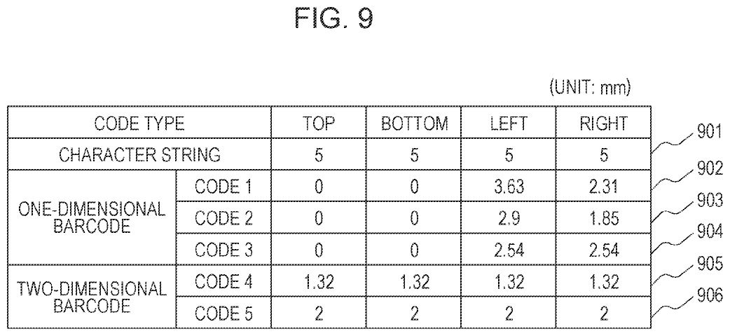

In step S704, the CPU 302 acquires margin information stored in the ROM 304 and necessary for the data inspection or the serial number inspection. In a case where the OCR is to be performed on the character string or in a case where the barcode is to be decoded, a certain amount of margin surrounding the character string or the barcode is necessary. In a case where the margin is not present, the character string or the barcode may not be accurately read. FIG. 9 illustrates an example of margin information necessary depending on a type of character string and types of barcodes. As the margin information for the character string and the barcodes, sizes standardized according to code types or margin amounts defined in programs to be executed in the OCR and the barcode decoding may be used. However, the margin information is not limited thereto. 901 indicates margin amounts read in a case where the character string inspection is set in the setting item 647. 902 to 906 indicate margin amounts read in a case where the barcode inspection is set in the setting item 648. Any of 902 to 906 is read according to the barcode type set in the setting item 650. While 902 to 904 indicate the margin amounts for a one-dimensional barcode, 905 and 906 indicate the margin amounts for a two-dimensional barcode.

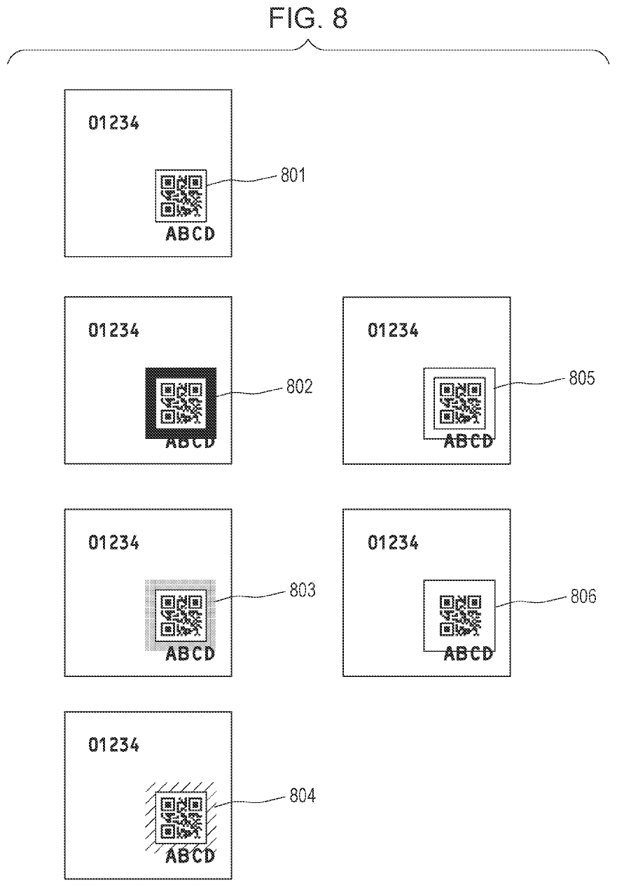

In step S705, the CPU 302 updates, based on the margin information acquired in step S704, display of an inspection frame for the area for which the inspection setting has been made. FIG. 8 illustrates examples of the display of the inspection frame. Although a two-dimensional barcode is described as an example with reference to FIG. 8, the same applies to left and right margin areas for a one-dimensional barcode. An area 801 indicates a position where the user sets an inspection area on the UI unit 320. An area 802 indicates an area obtained by extending the inspection frame outward by amounts indicated by the margin information acquired in step S704. The inspection frame is displayed such that a width of the inspection frame is increased. The area 802 is referred to as an area surrounding the inspection frame. In a case where image data is not present in the area (area surrounding the inspection frame) obtained by extending the inspection frame, it can be determined that a margin necessary for read processing is secured. In this case, the area obtained by extending the inspection frame is displayed in the same color as a color of the inspection frame set by the user, but may be displayed in a different color from the color of the inspection frame set by the user. In addition, as a method of displaying the inspection frame, transparent or translucent display may be performed to display, in a transparent or translucent color, the area obtained by extending the inspection frame, such as the translucent area or the like, as indicated by an area 803, in addition to the extension of the inspection frame, as indicated by the area 802. This makes it easier to visually check whether image data is present in the area obtained by extending the inspection frame. Furthermore, pattern display may be performed to draw a pattern such as a mesh as the area obtained by extending the inspection frame, as indicated by an area 804. Furthermore, double frame display may be performed to display a double frame by drawing a boundary of the area obtained by extending the inspection frame, as indicated by an area 805. The area obtained by extending the inspection frame may be displayed such that the position of the area obtained by extending the inspection frame is changed and only the boundary of the area obtained by extending the inspection frame is drawn, as indicated by an area 806. The display method is not limited thereto as long as a necessary margin area can be checked.

In the present embodiment, the inspection frame is extended outward from the inspection area set by the user, but is not limited thereto. The inspection frame may be extended inward. In addition, the inspection frame may be extended both inward and outward around a selected area. In the present embodiment, the timing of switching from the display of the area 801 to the display of any of the areas 802 to 806 is described in the description of step S705, but is not particularly limited. The inspection frame may be displayed, as indicated by any of the areas 802 to 806, for setting the area in the inspection setting screen 600 illustrated in FIGS. 6A and 6B. In addition, the display of the area 801 may be switched to the display of any of the areas 802 to 806 in response to pressing of a switch button (not illustrated) displayed in the inspection setting screen 600 by the user. Furthermore, the methods of displaying the areas 802 to 806 may be switched by pressing a switch display method button (not illustrated) displayed in the inspection setting screen 600.

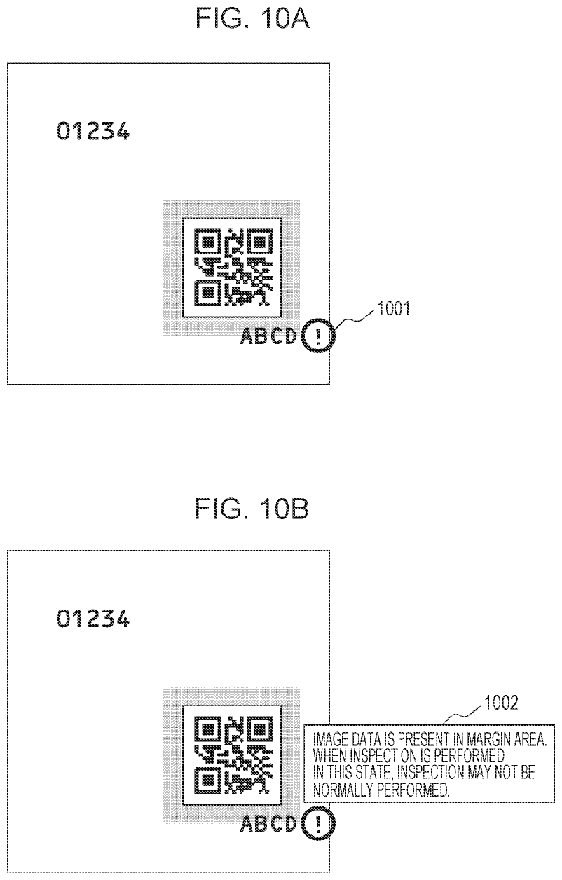

FIGS. 10A and 10B illustrate a screen for displaying a warning in a case where an object such as image data is present in or near the area obtained by extending the inspection frame in step S705. 1001 in FIG. 10A indicates an icon displayed in a case where the image data is present in the area obtained by extending the inspection frame. When a cursor of a mouse is placed over the icon 1001, a tooltip 1002 illustrated in FIG. 10B is displayed. In a case where the image data is present in the area obtained by extending the inspection frame as described above, a margin amount necessary for reading is not secured and the user can recognize that the reading may fail before the execution of the inspection. In this case, as the warning, the icon and the tooltip are displayed. However, the warning is not limited thereto. As the warning, a dialog may be displayed or the display form of the inspection frame may be changed (the inspection frame may blink or the like). The warning may be in any form as long as information indicating that the image data is present in the area obtained by extending the inspection frame can be notified to the user.

As described above, the inspection frame is displayed under a condition related to a margin area necessary for the data inspection before the execution of the inspection. Therefore, it is possible to check whether the necessary margin area is secured before the inspection and reduce the occurrence of a defect caused by an error in the settings for the inspection area.

Return to the description of FIG. 7.

When the display is updated in step S705, the process returns to step S701 and the CPU 302 waits for a notification of a UI operation.

Next, in step S706, the CPU 302 determines whether the settings for the inspection area have been completed.

In this case, the CPU 302 makes the determination by determining whether the button (OK button) 611 illustrated in FIG. 6A has been pressed. When the button 611 is pressed (YES in step S706), the CPU 302 determines that the inspection settings have been completed and the process proceeds to step S707. When the button 611 is not pressed (NO in step S706), the process returns to step S701 and the CPU 302 waits for a notification of a UI operation.

In step S707, the CPU 302 stores setting values set on the inspection setting screen to the RAM 303 and ends the inspection setting process.

The procedure of the inspection setting process in step S403 is described above.

As described above, according to the present embodiment, since the inspection frame is displayed under a condition related to a margin area necessary for the data inspection before the execution of the inspection, it is possible to check whether the necessary margin area is secured before the inspection and reduce the occurrence of a defect caused by an error in the settings for the inspection area.

### Second Embodiment

In the first embodiment, the method is described in which the inspection frame is displayed under a condition related to a margin area necessary for the data inspection, and thus it is possible to check whether the necessary margin area is secured before the execution of the inspection and reduce the occurrence of an error in the settings for the inspection area. However, in the method described in the first embodiment, when a printed part on a read image shifts in position, and the size of a character string or the size of a barcode changes by the shift in the position of the printed part on the read image from a margin area provided for a reference image, the reading of the character string or the barcode may fail. The shift in the position of the printed part is a shift in the position of the output part with respect to a sheet. The difference between the position of an output part on a sheet registered for a reference image and the position of the shifted printed part on the read image on the sheet is compared with the threshold.

In the present embodiment, a method of displaying an inspection frame based on a shift in the position of a printed part is described.

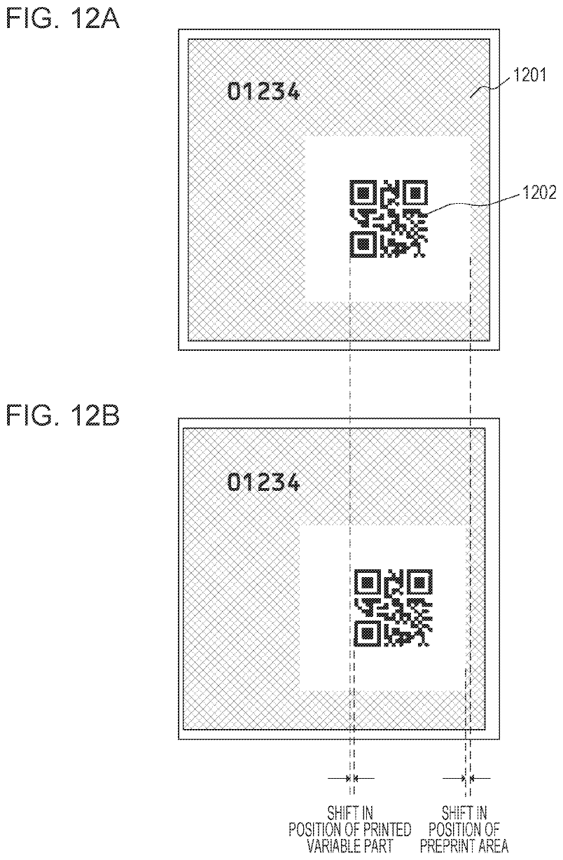

FIGS. 12A and 12B illustrate an example of a shift in the position of a printed part in the present embodiment. FIG. 12A illustrates a reference image. In FIG. 12A, an area 1201 is a preprint area in which data is printed on a sheet in advance. In an area 1202, variable data is printed. A barcode that differs for each sheet is printed in the area 1202. In the present embodiment, the barcode is described, but a character string, a serial number value, or the like may be printed.

FIG. 12B illustrates an image read during an inspection and illustrates an example when the preprint area shifts in position toward a left direction and a printed variable part shifts toward a right direction. In a case where margins for the area 1201 as the preprint area and the area 1202 as a variable area are 5 mm on the reference image, the area 1201 shifts in position by 1 mm leftward, and the variable area shifts in position by 1 mm rightward, a margin between the areas is 3 mm. In a case where a margin necessary for reading the variable area is 3.5 mm, the necessary margin is not sufficient and the reading of the barcode or the like may fail. Therefore, it is necessary to display the inspection frame based on a shift in the position of a printed part.

Features different from those described above in the first embodiment are described below in the present embodiment. Features that are not described in detail in the present embodiment are the same as or similar to those described in the first embodiment.

### Procedure of Inspection Setting Process

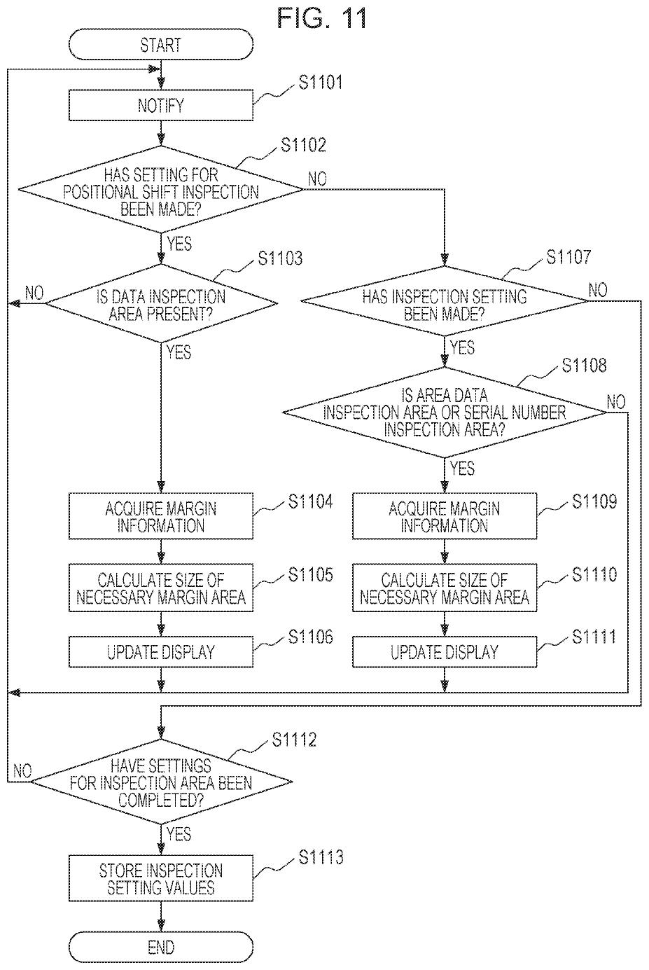

A procedure of an inspection setting process according to the second embodiment is described with reference to a flowchart illustrated in FIG. 11.

The process in the flowchart illustrated in FIG. 11 is implemented by the CPU 302 of the inspection apparatus 110 developing a program code stored in the ROM 304 into the RAM 303 and reading and executing the program code developed in the RAM 303.

Since step S1101 is similar to step S701 illustrated in FIG. 7, step S1101 will not be described.

In step S1102, the CPU 302 determines whether a setting for a positional shift inspection has been made.

Specifically, the CPU 302 determines whether one or more of the settings in the setting item 631 illustrated in FIG. 6A have been changed. When one or more of the settings in the setting item 631 are changed (YES in step S1102), the process proceeds to step S1103. When the settings in the setting item 631 are not changed (NO in step S1102), the process proceeds to step S1107. The CPU 302 determines whether one or more of values for the positional shift inspection have been changed. However, a function of inspecting a positional shift can be separately set to ON and OFF. The CPU 302 may determine whether the function of inspecting a positional shift has been switched to ON or OFF.

In step S1103, the CPU 302 determines whether a data inspection area is present in created inspection areas. When the data inspection area is present (YES in step S1103), the process proceeds to step S1104. When the data inspection area is not present (NO in step S1103), the process returns to step S1101 and the CPU 302 waits for a notification of a UI operation.

In step S1104, the CPU 302 acquires margin information of the created data inspection areas. In this case, the CPU 302 acquires the margin information of all the created data inspection areas.

Next, in step S1105, the CPU 302 calculates the size of a margin area to be displayed, based on setting values for the positional shift inspection set in step S1102 and the margin information acquired in step S1103. For example, in a case where the settings for the positional shift inspection in the setting item 631 are 2 mm in the vertical and horizontal directions, and the margin information acquired in step S1103 is the margin information 901, the CPU 302 calculates the size of the margin area according to the following equation. The amount (2 mm) of a shift in position on the inner side+the amount (2 mm) of a shift in position on the outer side+the margin amount (5 mm)=9 mm.

In this case, the CPU 302 calculates the size of a margin area for each of all the data inspection areas already created. In a case where the function of inspecting a positional shift is set to OFF, the CPU 302 calculates the sizes as 0 mm.

In step S1106, the CPU 302 updates, based on the size of each of the margin areas acquired in step S1105, display of an inspection frame for which inspection settings have been made.

In this case, the CPU 302 updates the display of the inspection frames for all the data inspection areas already created.

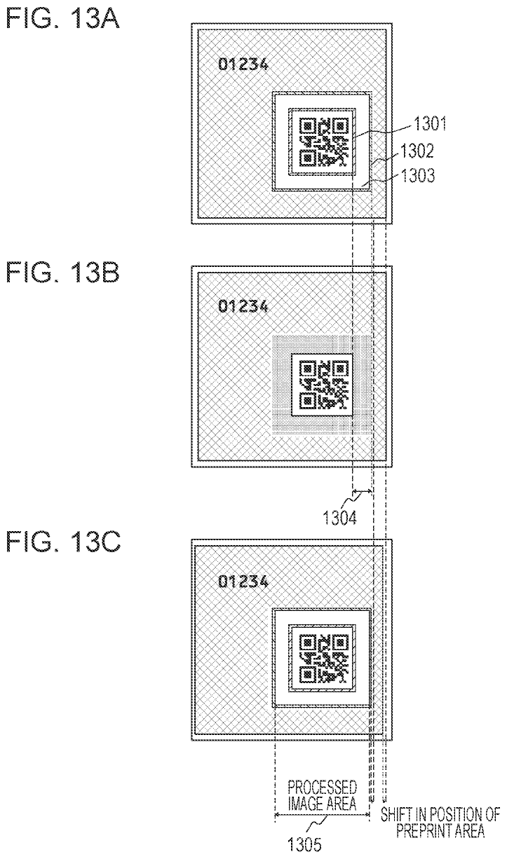

FIGS. 13A, 13B, and 13C illustrate examples of display of an inspection frame according to the second embodiment.

FIG. 13A illustrates an area shifted in position inward and an area shifted in position outward. In FIG. 13A, 1301 indicates the area shifted in position inward, 1302 indicates the area shifted in position outward, and 1303 indicates a margin area necessary depending on a code type of a data inspection. The area 1301 shifted in position inward is an area based on the assumption that a printed variable data part shifts in position. The area 1302 shifted in position outward is an area based on the assumption that a data part printed in a preprint area shifts in position.

FIG. 13B illustrates an inspection frame 1304 calculated based on the area 1301 shifted in position inward, the area 1302 shifted in position outward, and the margin area 1303 necessary depending on the code type of the data inspection.

FIG. 13C illustrates an image read during the inspection and illustrates an example in which a preprint area shifts in position leftward in printing. In FIG. 13C, a pattern in the preprint area is present in the area 1302 shifted in position outward. In an image used to read data, an area including a data area part, the area shifted in position inward, and the margin area necessary for the data inspection is processed as a processed image area 1305. Therefore, when it can be confirmed that image data is not present in the inspection frame 1304, the margin area is guaranteed in the processed image area to be used for the data inspection and it is possible to prevent a failure in the reading.

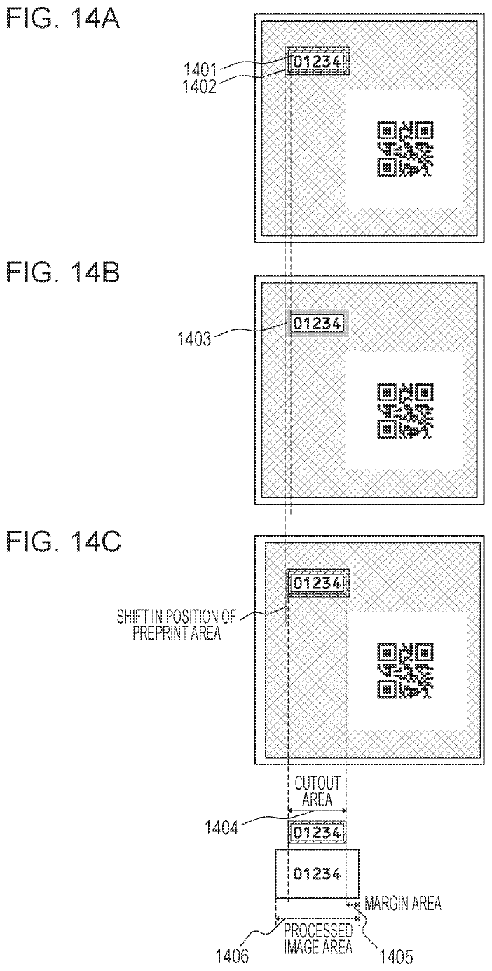

FIGS. 14A, 14B, and 14C illustrates an example of display of an inspection frame in a character string area according to the second embodiment.

A margin area necessary for the character string inspection is not standardized and depends on the performance of OCR. Therefore, as illustrated in FIG. 14A, the necessary margin area may not be displayed and the inspection frame may be displayed based on only the amount of a shift in position. In this case, the size of the margin area is calculated based on an inner inspection area 1401 and an outer inspection area 1402. FIG. 14B illustrates an inspection frame 1403 calculated based on the inner inspection area 1401 and the outer inspection area 1402.

FIG. 14C illustrates an image read during the inspection and illustrates an example in which the preprint area shifts in position rightward in printing. In FIG. 14C, a pattern in the preprint area is present in the outer inspection area 1402. In an image to be used to read data, an area including a data area part and the area shifted in position inward is treated as a cutout area 1404, and a margin area 1405 is provided outside the cutout area 1404 for the margin information acquired in step S1104. When the processed image area 1406 with the margin area 1405 provided is read and processed and it can be confirmed that image data is not present in the inspection frame 1403, the margin area is guaranteed in the processed image area used for the data inspection and it is possible to prevent a failure in the reading.

Return to the description of FIG. 11.

When the update of the display is completed in step S1106, the process returns to step S1101 and the CPU 302 waits for a notification of a UI operation.

Steps S1107 to S1109 are similar to steps S702 to S704 illustrated in FIG. 7 and thus will not be described.

In step S1110, the CPU 302 calculates the size of a margin area to be displayed, based on margin information acquired in step S1109 and setting values for the positional shift inspection in the setting item 631. Since a method of calculating the size is similar to step S1105 and thus will not be described.

In step S1111, the CPU 302 updates, based on the size of the margin area calculated in step S1110, the display of the inspection frame for the area for which the inspection settings have been made. Then, the process returns to step S1101 and the CPU 302 waits for a notification of a UI operation.

Processing in steps S1112 and S1113 is similar to the processing in steps S706 and S707 illustrated in FIG. 7 and will not be described.

The procedure of the inspection setting process in step S403 according to the second embodiment is described above.

In the present embodiment, the inspection frame is displayed based on a shift in the position of a printed part. However, the present embodiment is not limited thereto. The inspection frame may be displayed based on an inclination that occurs during the reading in the inspection, or may be displayed based on characteristics of the image forming apparatus 100 and the inspection apparatus 110.

In the second embodiment, the necessary margin amount is calculated based on the setting values for the positional shift inspection in the setting item 631. However, a setting item in which the amount of a shift in position that is used for calculating the margin amount can be set may be provided separately from the settings for the positional shift inspection.

As described above, according to the present embodiment, even when a printed part shifts in position, the inspection frame is displayed based on the shift in the position. Therefore, it is possible to check whether a necessary margin is secured before the inspection and reduce the occurrence of a defect caused by an error in the settings for the inspection area.

### Third Embodiment

In the second embodiment, the method is described in which even when a printed part shifts in position, the inspection frame is displayed based on the amount of the shift in the position, and thus it is possible to check whether the necessary margin is secured before the inspection and reduce the occurrence of a defect caused by an error in the settings for the inspection area.

However, in the methods described in the first and second embodiments, the user manually selects an area, and a margin that is larger than necessary may need to be provided.

In a third embodiment, a method is described in which a circumscribed rectangle of a printed area is automatically detected from an inspection area manually set by a user and an inspection frame is displayed based on the amount of a margin from the position of the detected rectangle.

In the present embodiment, features that are different from those described in the first and second embodiments are described. Features that are not described in detail in the present embodiment are the same as or similar to those described in the first and second embodiments.

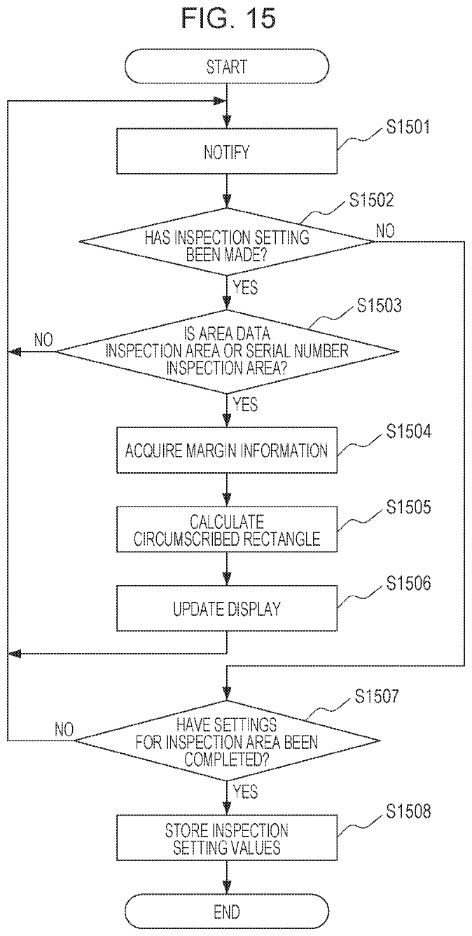

A procedure of an inspection setting process according to the third embodiment is described with reference to a flowchart illustrated in FIG. 15.

The process in the flowchart illustrated in FIG. 15 is implemented by the CPU 302 developing a program code stored in the ROM 304 into the RAM 303 and reading and executing the program code developed in the RAM 303.

Steps S1501 to S1504 are similar to steps S701 to S704 illustrated in FIG. 7 and thus will not be described.

In step S1505, the CPU 302 calculates a circumscribed rectangle of an area in which a character string or a barcode has been automatically printed from an inspection area set by the user in step S1502. The CPU 302 calculates the circumscribed rectangle by performing binarization processing on an image in the inspection area set by the user, and extracting coordinate positions of outermost black pixels. The calculation is not limited thereto as long as the circumscribed rectangle is extracted.

In step S1506, the CPU 302 updates display of the inspection frame based on the coordinates of the circumscribed rectangle calculated in step S1505 and margin information acquired in step S1504.

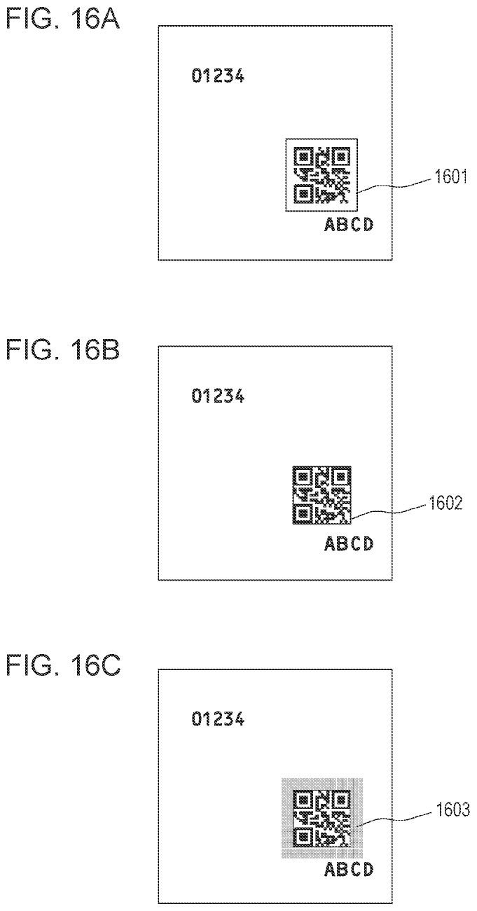

FIGS. 16A, 16B, and 16C illustrate examples of the display of the inspection frame according to the third embodiment.

FIG. 16A illustrates an inspection area 1601 selected by the user. FIG. 16B illustrates a circumscribed rectangle 1602 calculated in step S1505. FIG. 16C illustrates an inspection frame 1603 according to the third embodiment. Since the user sets the inspection area designated by the user and illustrated in FIG. 16A such that the inspection frame does not overlap a barcode, a margin is present between the inspection frame and the barcode. Therefore, a larger margin is necessary than the amount of a margin that is originally necessary. On the other hand, since the circumscribed rectangle is extracted and the inspection frame is set from the circumscribed rectangle, it is possible to eliminate the need for an extra margin.

Processing in steps S1507 and S1508 is similar to the processing in steps S706 and S707 and thus will not be described.

The procedure of the inspection setting process in step S403 according to the third embodiment is described above.

In the third embodiment, the circumscribed rectangle is extracted from the inspection area set by the user. However, areas in which a character string and a barcode are present may be extracted from a whole image, and inspection frames may be set from the extracted areas.

As described above, according to the present embodiment, an area in which the data inspection is performed is automatically detected, the inspection frame is displayed based on the amount of a margin from the position of the detected area, and thus it is possible to suppress an unnecessary margin.

Although the embodiments and the various examples of the embodiments are described above, the spirit and scope of the embodiments are not limited to the specific descriptions in the present specification.

According to embodiments of the present disclosure, it is possible to provide the inspection system that can display a margin necessary for the data inspection and identifiable before the execution of the inspection, and can reduce the occurrence of a defect caused by an error in the settings.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-063237, filed Apr. 10, 2023, which is hereby incorporated by reference herein in its entirety.

What is claimed is:

1. An information processing apparatus comprising:
one or more controllers having one or more processors and one or more memories, the one or more controllers being configured as:
an extractor configured to cause a reader to read a printed material sequentially conveyed from an image forming unit, and perform processing of extracting data from an image formed on the printed material;
a display controller configured to display a received image on a display unit; and
a setting unit configured to set, on the image displayed on the display unit, an area in which the extraction processing is performed, wherein
the display controller displays a margin area necessary for the extraction processing and identifiable with respect to the area set by the setting unit.

2. The information processing apparatus according to claim 1, wherein
the margin area necessary for the extractor and identifiable is displayed by the display controller using one or more of display methods including displaying an inspection frame such that a width of the inspection frame is increased, displaying the inspection frame in a transparent or translucent color, displaying a pattern, displaying a double frame, and displaying the inspection frame such that a position of the inspection frame is changed.

3. The information processing apparatus according to claim 1, wherein
the margin area necessary for the extractor and identifiable is displayed by the display controller using one or more of display methods including displaying an area surrounding an inspection frame such that a color of the area surrounding the inspection frame is different from a color of the inspection frame, displaying, in a transparent or translucent color, the area surrounding the inspection frame, and displaying a pattern in the area surrounding the inspection frame.

4. The information processing apparatus according to claim 1, the one or more controllers further being configured as:
an inspecting unit configured to inspect the printed material based on comparison of the data extracted by the extraction processing with correct data prepared in advance.

5. The information processing apparatus according to claim 1, wherein
the extraction processing by the extractor includes at least a first processing method and a second processing method, and
the setting unit selects any one of the first processing method and the second processing method and sets the area.

6. The information processing apparatus according to claim 5, wherein
a margin area that is displayed by the display controller and is necessary for the extractor in the first processing method is different from a margin area that is displayed by the display controller and is necessary for the extractor in the second processing method.

7. The information processing apparatus according to claim 5, wherein
the first processing method is decoding of a barcode and a QR code.

8. The information processing apparatus according to claim 5, wherein
the second processing method is OCR to be performed on a character area.

9. An inspection system comprising:
an image forming unit configured to form an image on a recording medium;
a reader configured to obtain a read image by reading the recording medium on which the image has been formed; and
one or more controllers having one or more processors and one or more memories, the one or more controllers being configured as:
an inspecting unit configured to extract data by extraction processing from an image formed on the read image, and inspect whether the extracted data matches correction data registered in advance;
a display controller configured to display at least the image on a display unit; and
a setting unit configured to set, on the image displayed on the display unit, an inspection frame for the inspection by the inspecting unit, wherein
the display controller displays the inspection frame set by the setting unit under a condition related to a margin area necessary for the extraction processing.

10. The inspection system according to claim 9, wherein
the inspection frame is displayed by the display controller using one or more of display methods under the condition related to the margin area necessary for the extraction processing, the display methods including displaying the inspection frame such that a width of the inspection frame is increased, displaying the inspection frame in a transparent or translucent color, displaying a pattern, displaying a double frame, and displaying the inspection frame such that a position of the inspection frame is changed.

11. The inspection system according to claim 9, wherein
the inspection frame is displayed by the display controller using one or more of display methods under the condition related to the margin area necessary for the extraction processing, the display methods including displaying an area surrounding the inspection frame such that a color of the area surrounding the inspection frame is different from a color of the inspection frame, displaying, in a transparent or translucent color, the area surrounding the inspection frame, and displaying a pattern.

12. The inspection system according to claim 9, wherein
the correct data prepared in advance is a CSV file.

13. The inspection system according to claim 9, wherein
the display controller displays a warning when another object is displayed and overlaps the margin area necessary for the extraction processing.

14. The inspection system according to claim 9, wherein
the display controller displays the inspection frame set by the setting unit, and
when the display controller receives an operation performed on a predetermined button for displaying the inspection frame under the condition related to the margin area necessary for the extraction processing, the display controller displays the inspection frame under the condition related to the margin area necessary for the extraction processing.

15. The inspection system according to claim 9, wherein
when the extracted data does not match the correct data registered in advance, the inspecting unit determines that the inspected recording medium is not acceptable.

16. An inspection system comprising:
an image forming unit configured to form an image on a recording medium;
a reader configured to obtain a read image by reading the recording medium on which the image has been formed; and
one or more controllers having one or more processors and one or more memories, the one or more controllers being configured as:
an extractor configured to extract data from an image formed on the read image;
a first inspecting unit configured to inspect whether the data extracted by the extractor matches correct data registered in advance;
a display controller configured to display at least the image on a display unit;
a first setting unit configured to set, on the image displayed on the display unit, an inspection frame designating an area from which the data is extracted by the extractor; and
a second setting unit configured to set, as a threshold, an allowable amount of a shift in a position of the image formed by the image forming unit, wherein
the display controller displays the inspection frame set by the first setting unit under a condition related to a margin necessary for extracting the data by the extractor and the threshold set by the second setting unit.

17. The inspection system according to claim 16, the one or more controllers being further configured as:
a second inspecting unit configured to inspect the shift in the position of the image formed by the image forming unit by using the threshold set by the second setting unit.

18. The inspection system according to claim 16, wherein
the inspection frame is displayed by the display controller using one or more of display methods under the condition related to the margin necessary for extracting the data by the extractor and the threshold set by the second setting unit, the display methods including displaying the inspection frame such that a width of the inspection frame is increased, displaying the inspection frame in a transparent or translucent color, displaying a pattern, displaying a double frame, and displaying the inspection frame such that a position of the inspection frame is changed.

19. The inspection system according to claim 16, wherein
the inspection frame is displayed by the display controller using one or more of display methods under the condition related to the margin necessary for extracting the data by the extractor and the threshold set by the second setting unit, the display methods including displaying an area surrounding the inspection frame such that a color of the area surrounding the inspection frame is different from a color of the inspection frame, displaying, in a transparent or translucent color, the area surrounding the inspection frame, and displaying a pattern.

20. A method of controlling an information processing apparatus, the information processing apparatus including a display unit configured to display a received image on a screen; and a controller configured to cause a reader to read a printed material sequentially conveyed from an image forming unit, and perform processing of extracting data from an image formed on the printed material, the method comprising:
setting, on the image displayed on the display unit, an area in which the extraction processing is performed; and
causing the display unit to display a margin area necessary for the extraction processing and identifiable with respect to the area set in the setting.

21. A method of controlling an inspection system, the method comprising:
forming an image on a recording medium;
obtaining a read image by reading the recording medium on which the image has been formed;
setting, on the image displayed on a display unit, an area from which data is extracted; and
extracting the data from an image formed on the read image and inspecting whether the extracted data matches correct data registered in advance, wherein
the set area is displayed under a condition related to a margin area necessary for the extracting.
